(19) United States
(12) Patent Application Publication
(10) Pub. No.: US 2007/0184958 A1
(43) Pub. Date: Aug. 9, 2007

(54) Heat pipe for a bag machine

(75) Inventors: Mitchell Hein, Green Bay, WI (US); Robert Beschta, Lena, WI (US); Lawrence D. Mikulsky, Green Bay, WI (US)

Correspondence Address: GEORGE R CORRIGAN, 5 BRIARCLIFF COURT, APPLETON, WI, 54915, US

(73) Assignee: CMD Corporation

(21) Appl. No.: 11/347,172

(22) Filed: Feb. 3, 2006

(51) Int. Cl. B31B 49/04

(52) U.S. Cl. 493/197

(57) ABSTRACT

A method and apparatus for bag making includes an input section, a sealing section and an output section. The sealing section includes a seal bar having a heat pipe with a relief zone, through which pressure is relieved. The heat pipe is preferably disposed in or near the seal bar. The relief zone can be a valve that opens and closes, or other reusable devices, or it can be a destructive relief zone. The heat pipe is preferably a generally closed cylindrical shape with the relief zone located on one end. The heat pipe can have a second relief zone, possibly located at the other end of the heat pipe. Fluid may be in the heat pipe. The invention can be implemented as a bag machine with a seal bar, or a seal bar with a heat pipe, or solely as a heat pipe.

### BACKGROUND OF THE INVENTION

There are many known bag machines. One style is a rotary drum machine. Rotary drum machines are well known, and found in U.S. Pat. Nos. 6,117,058, 4,934,993, 5,518,559, 5,587,032 and 4,642,084 (each of which is hereby incorporated by reference). Bag machine, as used herein, includes a machine used to make pouches bags such as draw tape bags, non-draw tape bags, and other bags.

A detailed description of the operation of rotary bag machines may be found in the patents above, or in prior art commercially available machines such as the CMD 1270GDS or 1503ED, but their general operation may be seen with respect to FIG. 1. A prior art rotary bag machine 100 continuously processes a web 201 using a dancer assembly 203, a pair of drum-in rolls 205 and 206 (203-206 are part of an input section). A sealing station includes a sealing drum 208, a pair of drum-out rolls 210 and 211, and a sealing blanket 213. A pair of knife-in rolls 215 and 216, a knife 218 (which could be any other web processing device such as a perforator, knife, die cutter, punching station, or folding station, before 215/216), a pair of knife-out rolls 219 and 220 are part of an output section. A controller 221 controls machine 100. Input section, as used herein, includes the portion of a bag machine where the web is received, such as an unwind and a dancer assembly. Output section, as used herein, includes processing stations that act on a web downstream of the seals being formed, such as winders, folders, etc. Sealing section or station, as used herein, includes a device that seals a film. Processing the film, as used herein, includes operations on the film, such as sealing, folding, winding, counting, perforating, etc.

The web is provided through dancer assembly 203 to drum 208. Drum 208 includes a plurality of seal bars 209. The seals bars are heated and create the seals forming the bags from web 201. The distance between seals created by the drum is related to the bag length (for bags formed end to end) or the bag width (for bags formed by making side seals). End to end bags are formed with one seal from the drum, and side to side bags are formed with a pair of seals. The drum diameter may be adjusted and/or less than all of the seal bars turned on to determine the distance between seals, and hence bag size.

After web 201 leaves drum 208 it is directed to rotary knife 218, which creates a perforation between bags, or could separate adjoining bags. Other downstream processing stations, such as winders, folders, etc.

Seal bars 209 can sometimes have multiple temperature zones, such as where a draw tape is being sealed. However, seal bars 209, as well as seal bars in other style machines, can develop unwanted localized hot spots. These hot spots can cause the film to thin or burn. The prior art has used heat pipes to reduce or avoid unwanted hot spots. Heat pipes are disposed within the seal bar, close to the heater. The heater is typically close to, but not on, the surface disposed to impart the seals to the film. The heat pipe could extend the entire length (cross machine direction) of the seal bar, or be in several sections for seal bars with multiple temperature zones. Surface disposed to impart a seal on a film, as used herein, includes a surface of any size or shape, and need not be flat.

Heat pipes (which are also used in other industries) are typically a sealed aluminum or copper container, and typically a cylinder in a bag making applications. The inner surface has a capillary wicking material and a liquid is in the pipe, which enters the capillaries, wetting all internal surfaces. Applying excess heat at a point along the surface of the pipe causes the liquid there to boil and enter a vapor state, which reduces temperature at that location. The gas moves inside the sealed pipe to a cooler location where it condenses, and heats that location via the condensing. Thus, heat is distributed from hot spots to cooler locations through convection and vaporization/condensing. Heat pipes can have an effective thermal conductivity much greater than that of copper. Heat pipes can be built in almost any size and shape. Heat pipes are commercially available from Noren®.

While some commercially available heat pipes are as described above, others are simpler, such as a closed container containing a liquid. Heat pipe as used herein, includes a pipe or container (which may be of any shape) used to transfer heat from one part of a seal bar to another to reduce the likelihood of hot spots on the seal bar.

If a heat pipe gets too hot, the pressure inside can cause a catastrophic failure—the heat pipe can explode. The prior art attempted to regulate the heat input into the seal bar to prevent overheating of the heat pipe. A thermocouple or other feedback device has been used, and when the seal bar or sensed temperature reached a threshold, the heat into the seal bar was temporarily reduced or ended. However, thermocouples and/or controls have failed, causing the heat pipe to catastrophically fail. Another attempt to prevent failure was to simply run the seal bars cooler, but this resulted in seals (and thus bags) not being properly made.

Accordingly, a heat pipe, and a bag machine having a heat pipe, that reduces or eliminates catastrophic failure, is desirable.

### SUMMARY OF THE PRESENT INVENTION

According to a first aspect of the invention a bag making machine includes an input section, a sealing section and an output section. The sealing section includes a seal bar having a heat pipe with a relief zone.

According to a second aspect of the invention a method of making bags includes receiving a film, applying at least one seal to the film and processing the film after sealing it. The sealing is done with a seal bar that has a heat pipe and pressure is relieved in the heat pipe through a relief zone when the pressure in the pipe near the relief zone substantially exceeds a desired level.

According to a third aspect of the invention a bag making machine includes an input section, a sealing section and an output section. The sealing section includes a seal bar having a heat pipe and the heat pipe has a means for relieving pressure within the heat pipe.

According to a fourth aspect of the invention a bag making machine includes an input section, a sealing section and an output section. The sealing section includes a seal bar having a heat pipe and the heat pipe has a means for relieving pressure within the heat pipe when the pressure substantially exceeds a desired level.

According to a fifth aspect of the invention a seal bar for a bag making machine has a surface that imparts a seal on a film, a heater, and at least one heat pipe disposed near the heater. The heat pipe has a relief zone on the at least one heat pipe.

According to a sixth aspect of the invention a method of preventing excess pressure in a heat pipe, such as that for a bag machine, includes relieving the pressure in the heat pipe through a relief zone when the pressure substantially exceeds a desired level.

According to a seventh aspect of the invention a heat pipe, such as that for bag making machine, is a pipe with a means for venting pressure when the pressure in the heat pipe near the means for venting substantially exceeds a desired level.

The relief zone includes a valve that opens to relieve pressure, that can be closed and reopened, or the relief zone can be a destructive relief zone in various embodiments.

The heat pipe is a generally closed cylindrical shape with the relief zone located on one end in another embodiment.

The heat pipe can have a second relief zone, possibly located at the other end of the heat pipe in another embodiment.

Fluid is in the heat pipe in another embodiment.

Other principal features and advantages of the invention will become apparent to those skilled in the art upon review of the following drawings, the detailed description and the appended claims.

### BRIEF DESCRIPTION OF THE DRAWINGS

FIG. 1 is a bag machine of the prior art;

FIG. 2 is an end view of a seal bar with a heat pipe in accordance with the preferred embodiment;

FIG. 3 is a cross sectional view of the seal bar of FIG. 2.

Before explaining at least one embodiment of the invention in detail it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting. Like reference numerals are used to indicate like components.

### DETAILED DESCRIPTION OF THE PREFERRED EMBODIMENTS

While the present invention will be illustrated with reference to a drum based bag making machine, using certain components, it should be understood at the outset that the invention may be implemented on other machines, such as shuttle machines, pouch machines, etc., and using other components. Also the invention may be a seal bar with a heat pipe and without the bag machine, or simply a heat pipe and without the seal bar or bag machine.

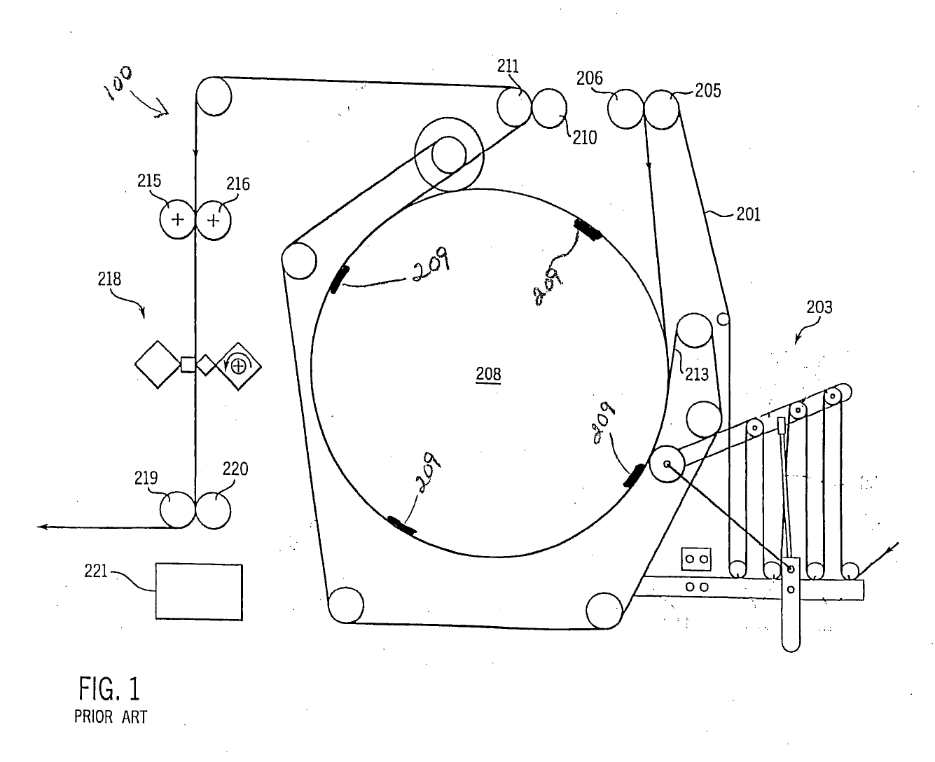

The invention may be implemented using a bag machine such as that shown in FIG. 1. The sealing section may also be a shuttle sealing section, a sealing section on a pouch machine, or any other seal bar, and there may be a plurality of sealing sections. The inventive heat pipe may also be used in other applications. The inventions may also be implemented with any input section (unwinds and dancers, e.g.) and any output section (winders, sealers folders, e.g.).

Generally, the invention includes a heat pipe that relieves pressure to prevent a catastrophic failure. The preferred embodiment provides that the pressure relief is provided through a relief zone. Relief zone, as used herein, includes an area or areas of a heat pipe through which an undesired excess pressure may be relieved, vented, reduced, or discharged. Various embodiments provide for a destructive relief zone, or a reusable, relief zone, such as a valve. Destructive relief zone, as used herein, includes a relief zone wherein when the relief zone relieves pressure a portion of the relief zone is destroyed.

When a destructive relief zone is used, it is generally a one-time use, and the heat pipe is rendered unusable and must be replaced or repaired. For example, a destructive relief zone can be a solder plug that melts at a temperature less than the material that comprises the heat pipe, or a thinned wall that bursts before the entire heat pipe catastrophically fails. In either case the relief is controlled to reduce the likelihood of an uncontrolled explosion. The relief may be based on temperature, pressure, or a combination of pressure and temperature.

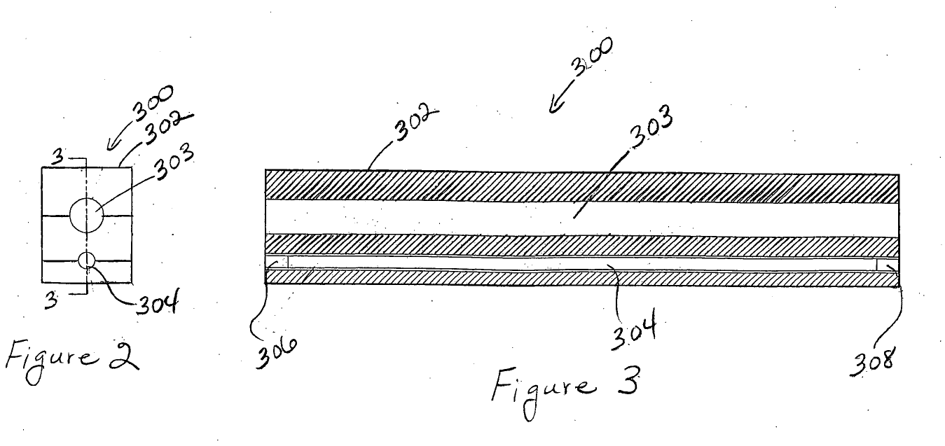

Referring now to FIGS. 2 and 3, an end view and a cross sectional view of seal bar 300, which may be used in place of seal bars 209 in the prior art. Seal bar 300 has a sealing surface 302, a heater 303, and a heat pipe 304 with a relief zone 306 is shown. Heat pipe 304 extends the length of seal bar 300 in this embodiment.

Heat pipe 304 can be similar (except for the relief zone) to a prior art heat pipe commercially available from CMD Corp. as part number 106131, which is a 0.375 inch diameter pipe, 60.00 inches long. However, in accordance with the preferred embodiment, relief zone 306 is provided and is provided with a relief zone 306. One alternative provides for a second relief zone 308.

Relief zone 306 is, in the preferred embodiment, a solder plug located at the end of heat pipe 300. The solder preferably has a melting range of 565-574 F, such as a solder comprised of 93.5% lead, 5% tin, and 1.5% silver.

When the temperature rises, and the pressure increases, the solder melts, and the pressure is relieved through the opening at the end of the heat pipe. Because the temperature melts the solder over a range, the temperature or pressure at the relief zone substantially exceeds threshold. Substantially exceeding a pressure, as used herein, includes the pressure being greater that a given value over a region for greater than an instantaneous period of time. The melting is caused by the high temperature, but it is load related to pressure in a closed system. Pressure in a closed system, such as heat pipe, is proportional to temperature, and therefore the use of pressure and temperature herein, is interchangeable when used herein, including the claims, to describe attributes of a closed system.

Alternative embodiments provide for relief zone 306 being a weakened wall or a valve, and/or relief zone 306 being located elsewhere, and/or additional relief zones. Relief zone 308, can likewise be a weakened wall, valve, and/or located elsewhere. Another alternative provides for heat pipe 304 to be located outside and adjacent seal bar 300.

Numerous modifications may be made to the present invention which still fall within the intended scope hereof. Thus, it should be apparent that there has been provided in accordance with the present invention a method and apparatus for a heat pipe and bag machine that fully satisfies the objectives and advantages set forth above. Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

The embodiments of the invention in which an exclusive property or privilege is claimed are defined as follows:

1. A bag making machine, comprising:
an input section;
a sealing section disposed to receive a film from the input section and apply at least one seal thereto, wherein the sealing section includes a seal bar having a heat pipe, wherein the heat pipe has a relief zone; and
an output section disposed to receive the film from the sealing section.

2. The bag making machine of claim 1, wherein the relief zone includes a valve.

3. The bag making machine of claim 2, wherein the valve is reusable.

4. The bag making machine of claim 1, wherein the relief zone is a destructive relief zone.

5. The bag making machine of claim 4, wherein the heat pipe has a generally closed cylindrical shape with a first end and a second end, and wherein the relief zone is located at the first end.

6. The bag making machine of claim 5, further comprising a second relief zone located at the second end.

7. The bag making machine of claim 6, further comprising a fluid disposed in the heat pipe.

8. The bag making machine of claim 7, further comprising a liquid disposed in the heat pipe, and wherein the heat pipe is within the seal bar.

9. A method of making bags, comprising:
receiving a film;
applying at least one seal to the film with at least one seal bar that includes a heat pipe;
relieving pressure in the heat pipe through a relief zone when the pressure in the pipe near the relief zone substantially exceeds a desired level; and
processing the film after sealing the film.

10. The method of claim 9, wherein relieving includes opening a valve.

11. The method of claim 10, further comprising closing the valve.

12. The method of claim 9, wherein relieving includes destroying at least a portion of the relief zone.

13. The method of claim 12, further comprising dispersing heat from hot zones on the at least one seal bar with a fluid in the heat pipe, and wherein the heat pipe is within the seal bar.

14. A bag making machine, comprising:
an input section;
a sealing section disposed to receive a film from the input section and apply at least one seal thereto, wherein the sealing section includes a seal bar having a heat pipe, wherein the heat pipe has a means for relieving pressure within the heat pipe; and
an output section disposed to receive the film from the sealing section.

15. The bag making machine of claim 14, wherein the heat pipe has a generally closed cylindrical shape with a first end and a second end, and wherein the means for relieving is located at the first end.

16. The bag making machine of claim 15, further comprising a fluid disposed in the heat pipe.

17. The bag making machine of claim 16, further comprising a liquid disposed in the heat pipe.

18. A bag making machine, comprising:
an input section;
a sealing section disposed to receive a film from the input section and apply at least one seal thereto, wherein the sealing section includes a seal bar having a heat pipe, wherein the heat pipe has a means for relieving pressure in the heat pipe when the pressure in the heat pipe near the means for relieving substantially exceeds a desired level; and
an output section disposed to receive the film from the sealing section.

19. The bag making machine of claim 18, wherein the heat pipe has a generally closed cylindrical shape with a first end and a second end, and wherein the means for relieving is located at the first end.

20. The bag making machine of claim 19, further comprising a fluid disposed in the heat pipe.

21. The bag making machine of claim 20, further comprising a liquid disposed in the heat pipe.

22. A seal bar for a bag making machine, comprising:
a surface disposed to impart a seal on a film;
at least one heat pipe in or adjacent the seal bar; and
a relief zone on the at least one heat pipe.

23. The seal bar of claim 22, wherein the relief zone includes a valve.

24. The seal bar of claim 23, wherein the valve is reusable.

25. The seal bar of claim 22, wherein the relief zone is a destructive relief zone.

26. The seal bar of claim 25, wherein the at least one heat pipe has a generally closed cylindrical shape with a first end and a second end, and wherein the relief zone is located at the first end.

27. The seal bar of claim 22, further comprising a fluid disposed in the at least one heat pipe.

28. The seal bar of claim 27, further comprising a liquid disposed in the at least one heat pipe.

29. The seal bar of claim 26, further comprising a second relief zone located at the second end.

30. A heat pipe, such as that for a bag machine, comprising a pipe, and a relief zone on the pipe, whereby when the pressure in the heat pipe near the relief zone substantially exceeds a desired level, the relief zone vents the pressure.

31. The heat pipe of claim 30, wherein the relief zone includes a valve.

32. The heat pipe of claim 31, wherein the valve is reusable.

33. The heat pipe of claim 30, wherein the relief zone is destructive relief zone.

34. The heat pipe of claim 33, wherein the heat pipe has a generally closed cylindrical shape, whereby the plurality of surfaces include a first end and a second end, and wherein the relief zone is located at the first end.

35. The heat pipe of claim 34, wherein the heat pipe has second relief zone located at the second end.

36. The heat pipe of claim 35, further comprising a fluid disposed in the heat pipe.

37. The heat pipe of claim 36, further comprising a liquid disposed in the heat pipe.

38. A method of preventing excess pressure in a heat pipe, such as that for a bag machine, comprising relieving the pressure in the heat pipe through a relief zone when the pressure in the pipe near the relief zone substantially exceeds a desired level.

39. The method of claim 38, wherein relieving includes opening a valve.

40. The method of claim 39, further comprising closing the valve.

41. The method of claim 38, wherein relieving includes destroying at least a portion of the relief zone.

42. A heat pipe, such as that for a bag machine, comprising:
a pipe; and
means for venting pressure when the pressure in the heat pipe near the means for venting substantially exceeds a desired level.

43. The heat pipe of claim 42, wherein the pipe has a generally closed cylindrical shape with a first end and a second end, and wherein the means for venting is located at the first end.

44. The heat pipe of claim 43, further comprising a second means for venting pressure when the pressure in the heat pipe near the second means for venting substantially exceeds a desired level.
